(19) United States
(12) Patent Application Publication
(10) Pub. No.: US 2025/0059091 A1
(43) Pub. Date: Feb. 20, 2025

(54) METHOD FOR PRODUCING CONSTRUCTION ELEMENTS FROM FLY ASH

(71) Applicant: Nghia Tran Trung, Ho Chi Minh City (VN)

(72) Inventors: Nghia Tran Trung, Ho Chi Minh City (VN); Hau Tran Trung, Bellevue, NE (US)

(73) Assignee: Nghia Tran Trung, Ho Chi Minh City (VN)

(21) Appl. No.: 18/719,271

(22) PCT Filed: Dec. 12, 2022
(86) PCT No.: PCT/VN2022/000011

§ 371 Date: Jun. 13, 2024

(30) Foreign Application Priority Data
Dec. 13, 2021 (VN) 1-2021-07981

(51) Int. Cl. C04B 18/08; C04B 28/04

(52) U.S. Cl. CPC C04B 18/085; C04B 18/088; C04B 28/04

(57) ABSTRACT

The invention pertains to a method for feeding fly ash into an unburnt brick mold. The method involves preparing a mixture of fly ash, cement, and water, with the fly ash constituting 70%-100% by weight, the cement 0%-30%, and the water 2%-27% of the total weight of the fly ash and cement. The fly ash and cement are thoroughly mixed, and water is added to achieve a moisture content of 5%-30%. The mixture is then formed into pellets with a cross-sectional size of 2-50 mm and optionally a length of 2-50 mm, using techniques such as extrusion, roll forming, pellet milling, or pelletizing. Finally, the pellets are fed into an unburnt brick mold using a conventional feeding system of an unburnt brick manufacturing machine.

### TECHNICAL FIELD

The present invention relates to a method for feeding fly ash into a mold to produce construction elements, in particular to unburnt bricks.

### BACKGROUND ART

Presently, there exists a difficulty if using merely one main ingredient, fly ash, to produce fly ash bricks, that it would be challenging to pour a mixture after moisture mixing into a mold having great depth in order to create a product with thin wall, for example a 4-hole brick of 80-80-180 mm size, having the hole diameter of 25 mm, while the mold having the depth of more than 200 mm and the clearance of only 10 mm, because of the greatly light relative density of separated fly ash (when not being compacted), less than 1. This causes the pouring of mixture into the mold uneven, especially in industrial manufacturing where a mold set consists of a plurality of product molds, the quality of products in each pressing time not the same, and the amount of manufacturing wastes large. It thus is impossible to apply this method in industrial manufacturing.

Therefore, there is a need for a solution to feed fly ash ingredient into a mold which can resolve aforementioned problems.

### SUMMARY OF THE INVENTION

An objective of the present invention is to resolve existing problems described above, particularly to provide a method for feeding fly ash into a mold to produce unburnt bricks.

The Applicant found that by producing fly ash pellets, the fly ash so produced has greater density and size, thereby being easily placed into the mold. Based on the above finding, the present invention has been completed.

Specifically, the present invention provides a method for feeding fly ash into a mold as follows:
(i) preparing main ingredients, comprising (% by weight): fly ash, cement and water, wherein the fly ash constitutes between 70% and 100%, the cement constitutes between 0% and 30%, and the water is present at an amount of between 2% and 27% of total weight of the fly ash and cement;
(ii) mixing well the fly ash with the cement, then adding the water into the composition and mixing again, so that the moisture content of the composition is 5% to 30%;
(iii) forming the composition by means such as extrusion, roll forming, pellet mill, pelletizing, in order to create the pellets of between 2 and 50 mm in cross-sectional size and of optionally between 2 and 50 mm in length;
(iv) feeding the pellets into an unburnt brick mold by a conventional feeding system of an unburnt brick production machine.

It is followed by a product shaping process of the unburnt brick manufacturing industry.

### DETAILED DESCRIPTION OF THE INVENTION

Fly ash used in the present invention is the one discharged from a thermal power plant, which can be either class F or class C fly ash, and typically contains silicon oxide, calcium oxide, aluminum oxide, iron oxide and carbon.

In one preferred embodiment of the present invention, there is provided a method for feeding fly ash into an unburnt brick mold, comprising:
(i) preparing main ingredients, comprising (% by weight): fly ash, cement and water, wherein the fly ash constitutes between 70% and 100%, the cement constitutes between 0% and 30% and the water is present at an amount of between 2% and 27% of total weight of the fly ash and cement;
(ii) mixing well the fly ash with the cement, then adding the water into the composition and mixing again, so that the moisture content of the composition is 5% to 30%;
(iii) forming the composition by means such as extrusion, roll forming, pellet mill, pelletizing, in order to create the pellets of between 2 and 50 mm in cross-sectional size and of optionally between 2 and 50 mm in length;
(iv) feeding the pellets into an unburnt brick mold by a conventional feeding system of an unburnt brick production machine.

In step (i), fly ash and cement are supplied commercially to an unburnt brick manufacturing plant, and stored inside bags or pumped to silos. Typically, the moisture content of fly ash and cement is about 2% to about 5%. The cement content may be 0% where class C fly ash is used, which has high calcium oxide content, greater than about 15%, enough for self-adhesion when pelletizing. Fly ash content is determined by the cement constituent in the composition.

In step (ii), fly ash, cement and water are quantitatively fed into a mixer, wherein the amount of water added into the composition of fly ash and cement is in the range of 2-27% of total weight of the composition, the commercial fly ash and cement have the typical moisture content of 3%, thereby the total amount of water is between 5% and 30% of total weight of the composition of fly ash and cement, most preferably between 15% and 20% because the forming can be easily performed. The amount of water greater than 30% is not preferred because it causes the fly ash mass after mixing to be viscous, pasty and unable to pelletize. The amount of water less than 5% is not sufficient to dampen fly ash particles, so that it is difficult to pelletize the fly ash because fly ash pellets are fragile.

In step (iii), the pellets are formed from the composition of fly ash, cement and water to cause the easy and uniform feeding of them into mold cavities. The pellets may be in cylindrical, spherical or any shape depending on pressing techniques. If extrusion or pelletizing is applied, they are generally in cylindrical shape of 2 mm to 12 mm, and of optionally up to 50 mm in length. The pellets are in any shape and of up to 50 mm in dimensions in case they are made by a roll forming roller, or they are in spherical shape of 50 mm in diameter if pelletized. Pellet size is determined by the mold size of the brick.

In step (iv), the pellets are quantified and fed into a feed system of an unburnt brick production machine and placed directly into brick molds.

In another preferred embodiment of the present invention, the feed composition further comprises other constituents which are mixed with constituents of the pellets before being formed. Other mixture constituents include constituents known in the art of construction element manufacturing, and are not limited to following described constituents: the group of aggregates for the purpose of increasing the density of the pellets, may be sand, stone powder or crushed-stone-like sand, or enhancing the activity of fly as such as ground granulated blast-furnace slag, multiple types of pozzolan such as volcanic ash, etc.; the group of inorganic binders such as calcium hydroxide, zeolite, bentonite, gypsum, CaO, MgO; the group of organic binders; the group of additives such as plasticizer-water reducing additives, waterproofing additives, colorants, strength-enhancing additives, etc.; the group of reinforcement fibers and particles such as glass fibers, polymer fibers, steel fibers, basalt fibers, etc.

The above feed constituents in small amounts can be mixed with fly ash to produce the pellets. The order of the mixing steps still falls within the protection scope and does not depart from the spirit of the present invention.

In another preferred embodiment of the present invention, fly ash, after being pelletized in step (iii), will be cured as same as the cement concrete so as to create aggregate pellets. Aggregate pellets can be used similarly to the natural rocks and aggregates. These aggregate pellets can further comprise other ingredients such as the group of finely ground aggregates, the group of binders, the group of additives, and reinforcement fibers and particles.

### EXAMPLES OF THE PRESENT INVENTION

Example 1: manufacturing brick having 4 holes of 25 mm in diameter which are arranged evenly on a square section of 80 mm, each brick of 180 mm in length. Each mold contains 4 previously-described-brick-size cavities that are located in a horizontal row and the distance between them is 120 mm:

Preparing ingredients, including:
Fly ash from Vinh Tan 2 thermal power plant: 800 kg (80% by weight)
Cement PC40: 200 kg (20% by weight)
Water: 150 kg (15% of total weight of fly ash and cement)

Carrying out the above-described method from step (i) to step (iii) to create pellets. Particularly, mixing the fly ash and cement with the water to make a semi-dry mixture, then, pouring the mixture into pelletizing machine to create pellets of 6 mm in diameter and 8 mm in length. Finally, obtaining about 1150 kg of pellets containing fly ash and cement, which are used for following experiments:

Feeding the pellets obtained above into a feeding system of an unburnt brick production machine, common dual-dynamic hydraulic pressing is applied, the experimental mold consists of 4 cavities arranged in a row associated with 4 pairs of upper and lower punches moving in parallel inside the mold cavities, the length of each mold cavity containing ingredients is 220 mm, the size of the brick shaping is 180 mm in length, the pressure applied on the mold is 10 MPa, the mold vibration time when feeding is 5 seconds, removing the mold to take out 4 shaped bricks, then weighing each brick and the measured values in grams (g) are shown below:

| | | | | | The error |
|---|---|---|---|---|---|
| | | | | | between |
| | | | | | the |
| | | | | | lightest |
| | | | | | and |
| | | | | | heaviest |
| Number of | The order of cavities | | | | bricks |
| experiments | Cavity 1 | Cavity 2 | Cavity 3 | Cavity 4 | (grams) |
| 1 | 1122 | 1148 | 1132 | 1153 | 31 |
| 2 | 1155 | 1131 | 1148 | 1127 | 32 |
| 3 | 1140 | 1132 | 1126 | 1149 | 23 |
| 4 | 1146 | 1157 | 1133 | 1131 | 26 |
| 5 | 1145 | 1158 | 1146 | 1153 | 13 |

| | |
|---|---|
| Average error (grams) | 25 |

Example 2: using the conventional feed method, no pelletizing, to produce 4-hole bricks like Example 1:

Preparing ingredients, including:
Fly ash from Vinh Tan 2 thermal power plant: 800 kg (80% by weight)
Cement PC40: 200 kg (20% by weight)
Water: 150 kg (15% of total weight of fly ash and cement)

Carrying out the conventional process, specifically, mixing the fly ash and cement with water to become a semi-dry mixture having moisture content of about 15%, then, feeding said mixture into a mold with the same specifications and applying forming process as

### Example 1

Removing the mold and weighing each brick, the measured values, in grams (g), are shown below:

| | | | | | The error |
|---|---|---|---|---|---|
| | | | | | between |
| | | | | | the |
| | | | | | lightest |
| | | | | | and |
| | | | | | heaviest |
| Number of | The order of cavities | | | | bricks |
| experiments | Cavity 1 | Cavity 2 | Cavity 3 | Cavity 4 | (grams) |
| 1 | 1005 | 874 | 989 | 850 | 155 |
| | | (broken) | | (broken) | |
| 2 | 976 | 889 | 855 | 993 | 138 |
| | | (broken) | (broken) | | |
| 3 | 982 | 855 | 970 | 990 | 135 |
| | | (broken) | | | |
| 4 | 986 | 997 | 837 | 923 | 149 |
| | | | (broken) | | |
| 5 | 997 | 847 | 936 | 854 | 150 |
| | | (broken) | | (broken) | |

| | |
|---|---|
| Average error (grams) | 145.4 |

It is shown by comparing Example 1 and 2 that with the same specifications and forming process:
the difference in weight of the feed mixture after pelletizing is more than 5 times smaller than that of non-pelletizing (25 g and 145.4 g), which means better mass uniformity, resulting in better product quality;
with the same cavity volume given, i.e. the same feed volume in the above two cases, the weight of the feed mixture after pelletizing in Example 1 is greater than that of non-pelletizing in Example 2, which means that the compactness of the bricks in Example 1 is better and accordingly, the product quality will be better.

Conclusion: Fly ash, after being pelletized, can be more easily and uniformly placed into a mold.

### Example 3: Producing Aggregate Pellets from Fly Ash

Preparing ingredients, including:
Fly ash from Vinh Tan 2 thermal power plant: 900 kg (90% by weight)
Cement PC40: 100 kg (10% by weight)
Water: 150 kg (15% of total weight of fly ash and cement)

Carrying out the process as described in step (i) to step (iii) of the above method to create aggregate pellets. In particular, mixing the fly ash and cement with water to become a semi-dry mixture, then, feeding said mixture into a pelletizer to create pellets of 6 mm in diameter and 8 mm in length. Finally, obtaining approximately 1150 kg of aggregate pellets containing fly ash and cement. Curing them like normal concrete for 28 days to obtain aggregate pellets. These aggregate pellets can be used as natural aggregates to prevent dust for fly ash waste after being pelletized, can be used to level or for road foundation.

This is a broader benefit of the present invention.

### Achievable Benefits of the Invention

The present invention successfully provides a method for feeding fly ash ingredient into a mold for unburnt brick manufacturing. The invention will increase the demand for employing fly ash to produce unburnt bricks, contributing to the decrease of fly ash amount discharged into the environment. Also, when being pelletized, the impact of fly ash waste on the water and air environment will be lessened.

What is claimed is:

1. A method for feeding fly ash into an unburnt brick mold comprising:
(i) preparing main ingredients, comprising (% by weight): fly ash, cement and water, wherein the fly ash constitutes between 70% and 100%, the cement constitutes between 0% and 30%, and the water is present at an amount of between 2% and 27% of total weight of the fly ash and cement;
(ii) mixing well the fly ash with the cement to form a feed composition, then adding the water into the feed composition and mixing again, so that the moisture content of the feed composition is 5% to 30%;
(iii) forming the feed composition by means of extrusion, roll forming, pellet mill, pelletizing; in order to create pellets of between 2 mm and 50 mm in cross-sectional size and between 2 mm and of optionally between 2 mm and 50 mm in length;
(iv) feeding the pellets into an unburnt brick mold by a feeding system of an unburnt brick manufacturing machine.

2. The method for feeding fly ash into the unburnt brick mold according to claim 1, wherein the feed composition further comprises:
(i) a group of aggregates for the purpose of increasing the density of the pellets, including sand, stone powder or crushed-stone-like sand, or enhancing the activity of fly as such as ground granulated blast-furnace slag, multiple types of pozzolan such as volcanic ash, etc.;
(ii) the group of inorganic binders such as calcium hydroxide, zeolite, bentonite, gypsum, CaO, MgO;
(iii) the group of organic binders;
(iv) the group of additives such as plasticizer-water reducing additives, waterproofing additives, colorants, strength-enhancing additives, etc.;
(v) the group of reinforcement fibers and particles such as glass fibers, polymer fibers, steel fibers, basalt fibers, etc.

3. The method for feeding fly ash into the unburnt brick mold according to claim 1, wherein the pellets obtained from step (iii) of claim 1, throughout concrete curing process are construction aggregate.

4. The method for feeding fly ash into the unburnt brick mold according to claim 3, wherein the pellets comprise the feed composition of claim 2.
